(19) United States
(12) Patent Application Publication
(10) Pub. No.: US 2014/0259567 A1
(43) Pub. Date: Sep. 18, 2014

(54) METHOD AND APPARATUS FOR APPLYING A CHARM ELEMENT

(71) Applicants: Marisa Colak, New South Wales (AU); Maryanne Bignill, New South Wales (AU); Vincenzina Capano, New South Wales (AU)

(72) Inventors: Marisa Colak, New South Wales (AU); Maryanne Bignill, New South Wales (AU); Vincenzina Capano, New South Wales (AU)

(21) Appl. No.: 13/261,864

(22) PCT Filed: Nov. 13, 2012
(86) PCT No.: PCT/AU2012/001397

§ 371 Date: May 14, 2014

(30) Foreign Application Priority Data
Nov. 14, 2011 (AU) 2011 904724

(51) Int. Cl. F16B 2/08; G09F 3/20

(52) U.S. Cl. CPC F16B 2/08; G09F 3/20
USPC 24/484

(57) ABSTRACT

A display band device for attaching to steering shaft of a push-scooter. The device includes: a collar element abuttingly releasably engageable to the shaft; and at least one attachment element for releasably engaging one or more display elements. The display element can be in the form of a charm element.

### FIELD OF THE INVENTION

The present invention relates to fasteners and in particular to fasteners for attaching to a shaft.

The invention has been developed primarily for use as display band device for attaching to a shaft of a push-scooter and releasably engaging one or more display elements, and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

### OBJECT OF THE INVENTION

It is an object of the present invention to overcome or ameliorate at least one of the disadvantages of the prior art, or to provide a useful alternative.

It is an object of the invention in its preferred form to provide a display band device for attaching to a shaft and releasably engaging one or more display elements.

### SUMMARY OF THE INVENTION

According to an aspect of the invention there is provided a display band device for attaching to a shaft, wherein the device is further adapted to releasably engage one or more display elements.

According to an aspect of the invention there is provided a display band device for attaching to a shaft, the device comprising:
a collar element abuttingly releasably engageable to the shaft; and
at least one attachment element for releasably engaging one or more display elements.

Preferably, the collar abuttingly engages about the circumference of the shaft. More preferably, the device is for use about the steering shaft of a push-scooter. Most preferably, the display band device is used about the steering shaft of a push-scooter.

Preferably the device includes a split collar that is resiliently biased to a closed configuration for abuttingly engaging the shaft. Alternatively, the collar element preferably has a flexible penannular configuration, and the device includes two complimentary coupling elements located proximal to opposite ends, such that the coupling elements are engageable, for enabling the a collar element to abuttingly releasably engage the shaft. Alternatively, the collar element is preferably a flexible elongate band, and the device includes two complimentary coupling elements located proximal to opposite ends, such that coupling elements are engageable, for enabling the collar element to abuttingly releasably engage the shaft.

Preferably, the device includes complimentary coupling elements for enabling the collar element to be abuttingly releasably engaged to the shaft. More preferably, the coupling elements are adapted to releasably engage the device to the shaft. Most preferably, the coupling element is according to any one or more of the configurations disclosed herein.

Preferably, the device includes a coupling means for enabling the collar element to be abuttingly releasably engaged to the shaft. More preferably, the coupling means is adapted to releasably engage the device to the shaft. Most preferably, the coupling means is according to any one or more of the configurations disclosed herein.

Preferably the attachment element is according to any one or more of the configurations disclosed herein. More preferably, the device includes a plurality of the attachment elements.

### BRIEF DESCRIPTION OF THE DRAWINGS

A preferred embodiment of the invention will now be described, by way of example only, with reference to the accompanying drawings in which:

FIG. 1A is a perspective view of an embodiment device;

FIG. 1B is a perspective view of the device of FIG. 1.

FIG. 2 is a perspective view of an embodiment device;

FIG. 3A is a perspective view of the device of FIG. 1, shown being releasably fixed to a shaft;

FIG. 3B is a perspective view of the device of FIG. 1, shown releasably fixed to a shaft;

FIG. 3C is a perspective view of the device of FIG. 2, shown releasably fixed to a shaft;

FIG. 4A-4D is a view of an embodiment device, shown with buckle reliefs;

FIG. 5 is a plan view of an embodiment device;

FIG. 6A-6D show an alternative collar element and coupling elements;

FIG. 7A-7B show an alternative collar element and coupling elements;

FIG. 8A-8B show an alternative collar element and coupling elements;

FIG. 9A-9B show an alternative collar element and coupling elements;

FIG. 10A-10C show an alternative collar element and coupling elements;

FIG. 11A-11C show an alternative collar element and coupling elements;

FIG. 12A-12B show an alternative collar element and coupling elements;

FIG. 13 shows an alternative collar element and coupling elements;

FIG. 14 shows an alternative collar element and coupling elements;

FIG. 15 shows an alternative collar element and coupling elements;

FIG. 16 shows an alternative collar element and coupling elements;

FIG. 17 shows an alternative collar element and coupling elements;

FIG. 18A-18C show an alternative collar element and coupling elements;

FIG. 19A-19B show an alternative collar element and coupling elements;

FIG. 20A-20C show an alternative attachment element;

FIG. 21A-21D show an alternative attachment element;

FIG. 22A-22B show an alternative attachment element;

FIG. 23A-23B show an alternative attachment element;

FIG. 24A-24C show an alternative attachment element;

FIG. 25A-25B show an alternative attachment element;

FIG. 26A-26B show an alternative attachment element;

FIG. 27A-27B show an alternative attachment element;

FIG. 28A-28B show an alternative attachment element;

FIG. 29 shows an alternative attachment element;

FIG. 30 shows an alternative attachment element;

FIG. 31 shows an alternative attachment element;

FIG. 32 shows an alternative attachment element;

FIG. 33A-33B show an alternative attachment element;

FIG. 34 shows an alternative attachment element;

FIG. 35A-35B is a perspective view of an embodiment device;

FIG. 36 is a perspective view of an embodiment device;

FIG. 37 is a perspective view of an embodiment device;

FIG. 38 is a perspective view of an embodiment display element;

FIG. 39 is a perspective view of an embodiment device;

FIG. 40A-40H show an embodiment device; and

FIG. 41A-41G show an embodiment display element, for use with the device of

FIG. 40A.

### PREFERRED EMBODIMENT OF THE INVENTION

Referring to the drawings, a display band device is shown for attaching to a shaft. The device being adapted to releasably engaging one or more display elements. It will be appreciated that the collar abuttingly engages about the circumference of the shaft. By way of example only, the device is typically used about the steering shaft of a push-scooter.

FIG. 1A and FIG. 1B show an embodiment display band device 100 for attaching to a shaft 190. The device comprises a collar element 110 abuttingly releasably engageable to the shaft. The collar element has a flexible penannular configuration, and the device includes complimentary coupling elements 120, 125 located proximal to opposite ends of the collar element, such that coupling element are engageable for enabling the collar element to abuttingly releasably engage the shaft. The device includes a plurality of attachment element 130 for releasably engaging one or more display elements 135 (for example charm elements).

By way of example, the collar element may he constructed from plastic, silicone, rubber or other suitable materials known in the art.

FIG. 2 shows an embodiment display band device 200 for attaching to a shaft 190. The device comprises a collar element 210 abuttingly releasably engageable to the shaft. The collar element has a flexible penannular configuration, and the device includes complimentary coupling elements (including 220) located proximal to opposite ends of the collar element, such that coupling element are engageable for enabling the collar element to abuttingly releasably engage the shaft. The device includes a plurality of attachment element 230 for releasably engaging one or more display elements 235.

In this embodiment device 200, the inner surface of the penannular collar element has a plurality of (typically, axial-directed) inwardly-protruding rib elements 240. The rib element can abuttingly engage the shaft element when the complimentary coupling elements are coupled together. The ribs can, by way of example, enable the width of the collar element body to be reduced and the collar element to be more flexible.

The display element can be inserted by hooking a portion of the display element (or charm) 235 through vertical slots attachment element 230.

Referring to FIG. 3A and FIG. 3B, the device 100 can he installed on a shaft 190 by first placing the penannular collar 110, and then coupling 310 the complimentary coupling elements 120, 125 to provide an abuttingly releasably engagement between the collar and the shaft. Referring to FIG. 3C, the device 200 can be installed on a shaft 190 by first placing the penannular collar 210, and then coupling 310 the complimentary coupling elements 220, 225 to provide an abutting releasable engagement between the collar and the shaft.

Referring to FIG. 4A through FIG. 4C, it will be appreciated that the upper 410 (or under 411) surface of a penannular collar element 100 may buckle or warp with a changing of the respective diameter when fixing the device to a shaft. Accordingly, buckle reliefs 410 may be included to encourage the collar element to more uniformly deform about its circumference, for example at substantially uniformly separates locations about the collar element. The buckle reliefs may be recesses that are pre-moulded into the collar element.

Referring to FIG. 4D, the collar element 100 can be hollow or defined by a “U” shaped channel. In this example embodiment 450, the collar element includes internal ribs 460 for adding strength to the upper surface, and to resist collapsing of the collar when changing of the respective diameter when fixing the device to a shaft—or when display elements are inserted.

Referring to FIG. 5, an embodiment device 500 can include a collar element 501 that include terminal abutment elements 502 and one or more intermediate abutment element 503. Each abutment element 502, 503 includes an abutment surface 504 for providing an abutting releasable engagement between the collar and the shaft 190. It is appreciated that the abutment elements are adaptations of the ribs shown in other embodiments.

The collar element can be made of resilient plastics or rubber. The abutment elements have resilient post regions 505 that can flex to accommodate different size diameter shafts.

FIG. 6A through FIG. 19B highlight alternative collar elements and/or coupling elements for embodiments devices. It will be appreciated that an embodiments device may include one or more of any of the collar elements and/or coupling elements disclosed herein.

In an embodiment, the device includes a split collar that is resiliently biased to a closed configuration for abuttingly engaging the shaft. Alternatively, the collar element has a flexible penannular configuration, and the device includes two complimentary coupling elements located proximal to opposite ends, such that coupling elements are engageable for enabling the collar element to abuttingly releasably engage the shaft. Alternatively, the collar element is a flexible elongate band, and the device includes two complimentary coupling elements located proximal to opposite ends, such that coupling element are engageable for enabling the collar element to abuttingly releasably engage the shaft.

It will be appreciated that, the device can include, by way of example only, complimentary coupling elements for enabling the collar element to be abuttingly releasably engaged to the shaft. These coupling elements are adapted to releasably engage the device to the shaft. The coupling elements are typically in the form according to any one or more of the configurations disclosed herein.

It will be appreciated that, the device can include, by way of example only, a coupling means for enabling the a collar element to be abuttingly releasably engaged to the shaft. The coupling means is adapted to releasably engage the device to the shaft. The coupling means is typically comprises any one or more of the coupling elements disclosed herein.

Referring to FIG. 6A through FIG. 6D, an embodiment device 510 can include a collar element 511 and cooperating male and female ratchet element (512 and 513 respectively). The collar element is a split annular collar, wherein the male and female ratchet elements are couplable to provide engagement of the opposite ends of the collar element for enabling a collar element to abuttingly releasably engage the shaft. It will be appreciated that a ‘ratchet style’ coupling element can accommodate a variety of shaft diameters when in a closed configuration (as best shown in FIG. 6B). To improve flexibility of the collar element, and enabling easier placement of the collar element about the shaft, the collar element can include a live hinge 514. The live hinge provides an advantage when the collar element is made of a hard plastic or rubber.

Referring to FIG. 7A and FIG. 7B, an embodiment device 520 can include a collar element 512 and a complimentary coupling element in the form of an overlapped ratchet element 522, 523. A band element 524 can be placed about the pair of ratchet elements 522, 523 for holding these coupling elements in a locked configuration (as shown in FIG. 7B).

Referring to FIG. 8A and FIG. 8B, an embodiment device 530 can include a peripheral collar element 531 coupled to an internal circlip element (or ‘C’ clip element) 532 for abuttingly releasably engaging the shaft. The internal circlip element is coupled to the collar element by internal radial ribs 533. In this embodiment, opposing terminal elements 535, 536 enable easier placement of the collar element about a shaft (not shown).

Referring to FIG. 9A and FIG. 9B, an embodiment device 540 can include an elongate collar element 541 comprising a resilient silicon radial strap 542, and the outer thick hand 542 that can be in the form of a relatively harder rubber. Alternatively, the thin strap and thick outer band can comprise the same material and/or be integrally formed. In this embodiment, the coupling elements are in the form of a protrusion 544 and receiving aperture 545. The protrusion 544 can he separately provided by a display element passed through an aperture.

Referring to FIG. 10A through FIG. 10C, an embodiment device 550 can comprise a collar element 551 in the form of a flexible band having a recess 552 for receiving a wrap around strap 553 (as shown in FIG. 10B). In this embodiment, the attachment element is in the form of an aperture 555 for receiving a protrusion 556 of a display element 557. It will be appreciated that the flexible band holds the collar in abutting releasable engagement with the shaft. It would be further appreciated that the wrap around strap can be integrally formed with the collar element, typically formed at one end of the collar element.

Referring to FIG. 11A through FIG. 11C, an embodiment device 560 can include a collar element 561 and complimentary coupling elements in the form of stud fasteners 562 and cooperating apertures 563. The apertures 563 can be located about the circumference of the collar element, allowing adjustment of the band diameter to suit a respective shaft 190. The stud element can he integrally formed with the collar element. As shown in FIG. 11C, lateral rib elements 565 can protrude from the inner surface of the collar element for providing separation of the band from the shaft.

Referring to FIG. 12A and FIG. 12B, an embodiment device 570 can include a collar element comprising a pair of interlockable extruded portions 571. Each extruded portion includes complimentary coupling elements for engaging the respective other interlockable portion. In this embodiment, each interlockable portion includes a male substantially ‘T’ shaped protrusion 572 and a respective female ‘T’ shaped recess 573. Each coupling element is configured to releasably engage its complimentary coupling element of the respective other collar portion. This enables the collar element to be formed about a shaft 190, as best shown in FIG. 12B. This embodiment can further include a plurality of lateral internal rib elements 575, that in use, are coaxial with the shaft. It would be appreciated the ribs are typically resilient, and movable to accommodate different shaft shapes and sizes.

Referring to FIG. 13, an embodiment device 580 can include a collar element 581 having complimentary coupling elements in the form of toothed portion 582 that is lockable within a complimentary band 583.

Referring to FIG. 14, an embodiment device 590 can include a collar element in the form of a strap 591, and complimentary coupling elements in the form of a buckle 592 and a receiving aperture 593.

Referring to FIG. 15, an embodiment device 600 includes a split penannular collar element 601 that is resiliently biased into a closed configuration for abuttingly engaging the shaft 190. The collar element has a plurality of attachment elements apertures 601 for releasably engaging one or more display elements 135.

Referring to FIG. 16, an embodiment device 610 can include a split collar 611 that is resiliently biased to a closed configuration for abuttingly engaging the shaft. Complimentary coupling elements are in the form of one or more Velcro bands can releasably fix the collar into location about the shaft. The Velcro bands can include attachment elements (for example apertures) for holding the display elements.

Referring to FIG. 17, an embodiment device 620 can include a collar element 621 having two portions 622, 623 interconnected by a hinge element 624. The hinge element 624 can, by way of example, be a live hinge. Such that the collar element portions 622, 623 can comprise substantially resilient material. In this embodiment, internal lateral rib elements that are, when in use, coaxial with the shaft 190 for accommodating different shaft diameters.

Referring to FIG. 18A through FIG. 18C, an embodiment device 630 can include a collar element 631 having coupling elements 632, 633, such that a flexible fastening element 635 can be simultaneously retain both coupling elements. It would be appreciated that the coupling elements 632, 633 can he protrusions (as shown in FIG. 18A) or retaining recesses (as shown in FIG. 18B).

Referring to FIG. 19A and FIG. 19B, an embodiment device 640 can include a collar element comprising two portions 641,642 that form a rigid moulded snap-locking 643,644 case with live hinge 645 (as shown in FIG. 19A). Alternatively, a embodiment device 650 can include collar element comprising two portions 651,652 can form of a pair of rigid plastic halves having a screw attachments 653.

FIG. 20A through FIG. 34 highlight embodiments devices having a range of attachment elements for releasably engaging one or more display elements (for example charm elements). It will be appreciated that an embodiments device may include one or more of any of the attachment elements disclosed herein.

It will be appreciated that the attachment element can be in the form according to any one or more of the configurations disclosed herein. The device typically includes a plurality of the attachment elements.

Referring to FIG. 20A, the device 700 includes a collar element 701 that defines a penannular form comprising a resilient material, such that the gap 702 can be expanded to receive the shaft 190, and the band being biased to a closed abutting engaged configuration about the shaft. The internal aperture of the collar may be ribbed 703 for enabling an abutting engagement about shafts of various diameters.

An elongate circumferential aperture 704 can be inscribed about part of the circumference of the collar, to define an attachment element for receiving, and engaging, one or more display element 705.

By way of example, the display element 705 may comprise a shaft 706 and having an enlarged fixing element 707 proximal to one end. In attaching the display element, the fixing elements 707, and shaft 706, can be passed through the attachment element of the collar of the device, wherein the enlarged fixing element abuttingly engages the inner surface of the collar to provide releasable fixing of the display element. In this embodiment, the enlarged fixing element is located in the space between adjacent ribs.

Referring to FIG. 21A through FIG. 21D, an embodiment device 710 includes an elongate collar element 711, having ribs 712. Then the device is installed on a shaft (not shown) the ribs are substantially coaxial with the shaft. In this embodiment, the attachment element is a through passage 713 (best shown in FIG. 21D). The through passage can be located between the ribs (as shown in FIG. 12B and FIG. 21C) or otherwise (as shown in FIG. 21D). The display element 714 can include a rectangular section 715 for retaining the display element, and maintaining orientation by locating in axially alignment between the ribs.

Referring to FIG. 22A and FIG. 22B, an embodiment device 720 includes a penannular collar element 721 formed as a substantially toroidal structure generated by rotating a U shaped section 722 about the axis 723. In this embodiment, the attachment element is an aperture 724 defined within the outer wall 725 of the collar. In this embodiment, the display element 726 is inserted, at least partially, through the attachment element aperture, wherein the resilient material of the collar enables the enlarged fitting element 727 to be placed through the aperture to provide releasable engagement of the display element.

Referring to FIG. 23A and FIG. 23B, an embodiment device 730 includes an engagement element that comprises a protrusion 732 located about the circumference of the collar 731. In this embodiment the display element 733 includes a corresponding female attachment element 734 for providing releasable engagement between the device and display element (as best shown in FIG. 23B). It would be appreciated that a further embodiment would include an attachment element in the form of a magnetic element located about the collar for engaging a magnetic couplable display element.

Referring to FIG. 24A through FIG. 24C, an embodiment device 740 includes a collar element 741 comprising an outer surface 742 that has axially directed ribs 743. The attachment element can be in the form of receiving recess (or hole) 744 located proximal to the periphery of the collar. The display element 745 can include one or more elongated arms 746 (as shown in FIG. 24B) that are insertable through the attachment element recesses 744 for providing releasable engagement between the device and display element. As shown in FIG. 24C, the device need not include external ribs.

Referring to FIG. 25A and FIG. 25B, an embodiment device 750 includes an attachment element in the form of a ‘T’ section 751. The display element 755 can be releasably engaged to the device by sliding a pair of ‘L’ brackets 756 located at the rear of the display element, over the extending arms of the ‘T’ section 751.

Referring to FIG. 26A and FIG. 26B, an embodiment device 760 includes an attachment element in the form of an circular aperture 761 a collar element and having a circumferential rib 762. A display element can be in the form of a circular button 763 having a circumferential groove 764 that can releasably engage the rib 762 upon pressing the display element 763 through the aperture 761.

Referring to FIG. 27A and FIG. 27B, an embodiment device 770 includes an attachment element in the form of a substantially rectilinear aperture 771. The display element 775 having a releasable coupling element in the form of a shaft 776 with an enlarged rectilinear portion at its end 777. Releasable engagement of the display element with the device can be achieved by placing the rectilinear end portion 777 of the shaft through the rectilinear attachment element aperture 771, and rotating the display element (preferably through about 90° as best shown in FIG. 27B).

Referring to FIG. 28A and FIG. 28B, an embodiment device 780 includes an engagement element in the form of a through aperture 781. The display element 785 having a pair of pliable legs 786. Releasable engagement of the display element with the device can he achieved by placing the legs 786 through the through aperture 781, and then bending the legs outwardly to engage an inner surface of the collar 782.

Referring to FIG. 29, an embodiment device 790 includes an engagement element in the form of a threaded aperture 791. The display element 795 having a threaded shaft 796 that can releasably threadedly engage the device.

Referring to FIG. 30, an embodiment device 800 includes an engagement element in the form of a cylindrical recess 801. The display element 805 having a shaft 806 comprises a resilient material that includes one or more barb portions 807, to thereby enabling a firm press fit between the display element and device engagement element.

Referring to FIG. 31, an embodiment device 810 includes an engagement element in the form of a through passage 811. The display element 815 include a shaft 816 having an enlarged end portion 817. The display element can releasably engage the device by inserting the enlarged end portion through the through passage. The enlarged end portion can resist withdrawal of the display element. It would be appreciated that the collar 812 can comprise a resilient material to enable stretching of the through aperture 811. Alternatively, the shaft and enlarged end portion can be comprised of a resilient material.

Referring to FIG. 32, an embodiment device 820 includes an engagement element in the form of notches 821. The display element 825 include a band 826 that can he received by the notch. The band 826 radially encircles the collar element 822 for releasably engaging the display element to the device.

Referring to FIG. 33A and FIG. 33B, an embodiment device 830 includes an engagement element in the form of a circumferential ‘T’ shaped recess 831 (as best shown in FIG. 33B). A display element (not shown) can include a ‘T’ shaped protrusion that can be received by the engagement element for releasably engaging the display element to the device.

Referring to FIG. 34, an embodiment device 840 can include a plurality of engagement elements in the form of an axially directed ‘T’ shaped recess 841. The ‘T’ shaped recess 841 typically extend from an upper or lower surface of the collar. In this embodiment the display element downwardly (or upwardly) slideably engages the device. A plurality of devices may be placed on a shaft 190, whereby typically the upper band is placed in an orientation that does not expose the ‘T’ shaped recess 841.

Further alternative configurations of the display band device are disclosed in FIG. 35A through FIG. 39.

Referring to FIG. 35, an embodiment device 850 can include a collar element comprising two penannular (or toroidal) portions 851, 852 having a ‘wave’ profile upper surface 853 and lower surfaces 854. The portions can snap together to form one or more engagement element 855 in the form of a through passage (or alternatively a recess). A display element 856 can be added before (or alternatively after) the portions are snap locked together.

Referring to FIG. 36, an embodiment device 860 can include a collar element comprising two penannular (or toroidal) portions 861, 862 that are threadedly engageable 863.

Referring to FIG. 37, an embodiment device 870 can include a collar element 871 that locate about the shaft 190 in an off-centre configuration.

Referring to FIG. 38, an embodiment device 880 can include a display element 881 that is adapted to receive a plurality of sub-display elements 882 (typically being smaller display elements or charms).

Referring to FIG. 39, it will be appreciated that a plurality of embodiment devices 890 can be installed on a shaft—for example displaying a plurality of animal shaped display elements.

FIG. 40A through FIG. 40H show, by way of example only, an embodiment display band device. The display device 900 includes a elongate collar element 910 for abuttingly releasably engageable to a shaft (not shown).

The band device 910 includes a plurality of spaced coupling apertures 912, such that when the band is firmly wrapped around a shaft coupling apertures located proximal to opposite ends of the band come into alignment for receiving a respective coupling element in the form of a shaft element (or barb element) to releasably couple opposite ends of the band for enabling the collar element to be abuttingly releasably engaged to a shaft. It will be appreciated that, unused coupling elements can then become available as attachment elements 912 for releasably engaging one or more display elements (best shown in FIG. 41A).

In this example, the band device 910 is about 230 mm long and about 27 mm wide. One end of the band 911 (for example proximal to a terminal rib element 921) can be tapered to have a outer radius of about 20 mm 914 (as shown in FIG. 41D).

In this example, the inner surface of the resilient elongate collar band device 910, has a plurality of spaced inwardly-protruding rib elements 920. By way of example only, the rib elements can be spaced having a pitch of about 19 mm-20 mm 922, and defining an intermediate valley having an internal angle of about 32 degrees 923. The band has an overall length of about 230 mm, with the rib elements occupying a region about 140 mm in length defined from one end of the band. To benefit fitting of the band device about a shaft, the inner surface of the rib element is a concave surface, for example having a radius of about 10 mm 924—having a centre about 25 mm from the band's outer surface 925.

FIG. 40E shows an enlarged detailed view of the section 930 of FIG. 40C. The coupling aperture (or attachment element/aperture) 932 is shown to be about 7 mm (axially directed) 933 and about 3 mm wide 934.

FIG. 40F shows an example profile of the band element 910 and rib elements. The height 941 of the rib element 920 being about 16 mm from the rib inner surface 942 to outer surface of the band 943, and having upper and lower surfaces being inwardly directed to an angle of about 32 degrees 945. The profile being further defined by radii 946 and 947—being about 10 mm 2 mm respectively.

FIG. 40G and FIG. 40H show a sectional side view 950. 951, showing the coupling aperture (or attachment element or aperture) 912. In image 952 can be embossed about the area of each coupling aperture (or attachment element or aperture) 912. This can be embossed, for example, to a depth of about 0.3 mm.

FIG. 41A through FIG. 41G shows, by way of example only, an element 960 that can be used both as a coupling element and an attachment element.

The element 960 can includes a shaft portion 961 and a barb portion 962. In this example, the shaft portion is about 5.4 mm long, having an substantially oval cross section (best shown in FIG. 41G) having major axis and minor axis of about 7.5 mm by 3.5 mm respectively. The barb portion having an outer dimension of about 16.5 mm by 5.5 mm.

The display element can further define an outer surface 963 for presenting, or attaching a charm image. The display surface being about 10 mm in diameter.

It will be appreciated that, the band element can be sufficiently elastic (or flexible or resilient) to enable a respective receiving apertures (for example, apertures 912 and 913 of FIG. 40A) to receive the barb portion 962, thereby enabling the sharp portion 961 to retain opposite ends of the band about a shaft. The length of the shaft portion being sufficient to receive a double thickness of the band. In this example embodiment the barb portion 962 has a barb approach angle of about 80 degrees.

It will be appreciated that the illustrated display band device can attaching to a shaft and releasably engaging one or more display elements. The collar can abuttingly engage about the circumference of the shaft, and can be used about the steering shaft of a push-scooter.

Although the invention has been described with reference to specific examples, it will he appreciated by those skilled in the art that the invention may be embodied in many other forms.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected”, along with their derivatives, may be used. It should he understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

As used herein, unless otherwise specified the use of terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader, or with reference to the orientation of the structure during nominal use, as appropriate. Similarly, the terms “inwardly” and “outwardly” generally refer to the orientation of a surface relative to its axis of elongation, or axis of rotation, as appropriate.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. A display device for attaching to a shaft, the device comprising:
a collar element abuttingly releasably engageable to the shaft; and
at least one attachment element for releasably engaging one or more display element.

2. The device according to claim 1, wherein the device is releasably engaged to one or more display element.

3. The device according to claim 1, wherein the collar element abuttingly engages about the circumference of the shaft.

4. The device according to claim 1, wherein the collar element is a split collar that is resiliently biased to a closed configuration for abuttingly engaging the shaft.

5. The device according to claim 1, wherein the collar element has a flexible penannular configuration, and the device includes two complimentary coupling elements located proximal to opposite ends, such that the coupling elements are engageable, for enabling the collar element to abuttingly releasably engage the shaft.

6. The device according to claim 1, wherein the collar element is a flexible elongate band, and the device includes two complimentary coupling elements located proximal to opposite ends, such that coupling elements are engageable, for enabling the collar element to abuttingly releasably engage the shaft.

7. The device according to claim 1, wherein the device includes complimentary coupling elements for enabling the collar element to be abuttingly releasably engaged to the shaft.

8. The device according to claim 5, wherein the coupling elements are adapted to releasably engage the device to the shaft.

9. The device according to claim 1, wherein the device includes a coupling means for enabling the collar element to be abuttingly releasably engaged to the shaft.

10. The device according to claim 9, wherein the coupling means is adapted to releasably engage the device to the shaft.

11. The device according to claim 1, wherein the device includes a plurality of attachment elements.

12. The device according to claim 1, wherein each attachment element is releasably engaged to at least on one display element in the form of a charm element.

13. The device according to claim 1, wherein the collar element is abuttingly releasably engaged to the shaft.

14. The device according to claim 1, when used about the steering shaft of a push-scooter.

15. (canceled)

16. The device according to claim 2, wherein the collar element abuttingly engages about the circumference of the shaft.

17. The device according to claim 2, wherein the collar element is a split collar that is resiliently biased to a closed configuration for abuttingly engaging the shaft.

18. The device according to claim 3, wherein the collar element is a split collar that is resiliently biased to a closed configuration for abuttingly engaging the shaft.

19. The device according to claim 2, wherein the collar element has a flexible penannular configuration, and the device includes two complimentary coupling elements located proximal to opposite ends, such that the coupling elements are engageable, for enabling the collar element to abuttingly releasably engage the shaft.

20. The device according to claim 3, wherein the collar element has a flexible penannular configuration, and the device includes two complimentary coupling elements located proximal to opposite ends, such that the coupling elements are engageable, for enabling the collar element to abuttingly releasably engage the shaft.

21. The device according to claim 2, wherein the collar element is a flexible elongate band, and the device includes two complimentary coupling elements located proximal to opposite ends, such that coupling elements are engageable, for enabling the collar element to abuttingly releasably engage the shaft.
